(19) United States
(12) Patent Application Publication
(10) Pub. No.: US 2019/0187816 A1
(43) Pub. Date: Jun. 20, 2019

(54) MOUSE WITH CAPACITANCE FINGERPRINT SENSOR

(71) Applicant: Yung-Lung Liu, Taichung City (TW)

(72) Inventor: Yung-Lung Liu, Taichung City (TW)

(73) Assignee: Sunrex Technology Corp., Taichung City (TW)

(21) Appl. No.: 16/105,542

(22) Filed: Aug. 20, 2018

(30) Foreign Application Priority Data
Dec. 18, 2017 (TW) 106218719

(51) Int. Cl. G06F 3/038; G06F 3/0354; G06K 9/00

(52) U.S. Cl. CPC G06F 3/0383; G06K 9/0002; G06F 3/03543

(57) ABSTRACT

A mouse includes a housing; a mouse interface circuitry disposed in the housing; a capacitance fingerprint sensor disposed on a top of the housing and electrically connected to the mouse interface circuitry; and a microprocessor disposed on the mouse interface circuitry and electrically connected to the capacitance fingerprint sensor. The capacitance fingerprint sensor includes a fingerprint image acquisition unit for capturing a user's fingerprint when the user's finger is positioned on the capacitance fingerprint sensor, and a fingerprint image conversion unit for converting the user's fingerprint into fingerprint signals. Thus, the mouse may be used to identify users who wish to access a computer.

### BACKGROUND OF THE INVENTION

### 1. Field of the Invention

The invention relates to computer mice and more particularly to a mouse with a capacitance fingerprint sensor mounted on a top.

### 2. Description of Related Art

U.S. Pat. No. 6,337,919 to Dunton discloses a mouse comprising a substantially radiation transmissive mouse button; a fingerprint sensor to capture an image of a fingerprint when the user's finger is positioned over the mouse button; the fingerprint sensor comprising a light source to direct light through the mouse button, an optical, system for receiving light reflected from the user's finger over the mouse button and a sensor, wherein the light source, optical system and sensor are mounted to move with the mouse button. In short, radiation directed at the user's finger through the mouse button may be captured for image analysis and ultimately for fingerprint identification. Thus, the mouse may be used to identify users who wish to access a computer system.

While the device enjoys its success in the market, continuing improvements in the exploitation of computer mouse with security features are constantly being sought.

### SUMMARY OF THE INVENTION

It is therefore one object of the invention to provide a mouse comprising a housing; a mouse interface circuitry disposed in the housing; a capacitance fingerprint sensor disposed on a top of the housing and electrically connected to the mouse interface circuitry; and a microprocessor disposed on the mouse interface circuitry and electrically connected to the capacitance fingerprint sensor.

The above and other objects, features and advantages of the invention will become apparent from the following detailed description taken with the accompanying drawings.

### BRIEF DESCRIPTION OF THE DRAWINGS

FIG. 1 is a perspective view of a mouse according to the invention;

FIG. 2 is a view similar to FIG. 1 with the capacitance fingerprint sensor disengaged;

FIG. 3 is a longitudinal sectional view of the mouse of FIG. 1;

FIG. 4 schematically depicts the capacitance fingerprint sensor being touched by the finger; and

FIG. 5 is a block diagram of the fingerprint image acquisition and processing device incorporated into the mouse of the invention.

### DETAILED DESCRIPTION OF THE INVENTION

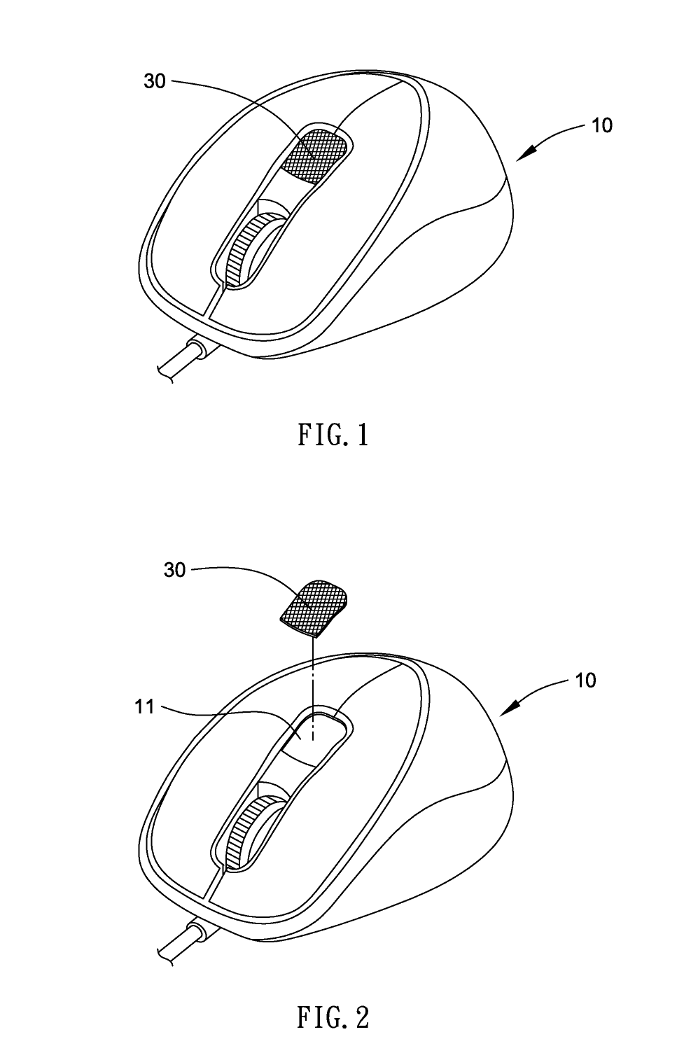

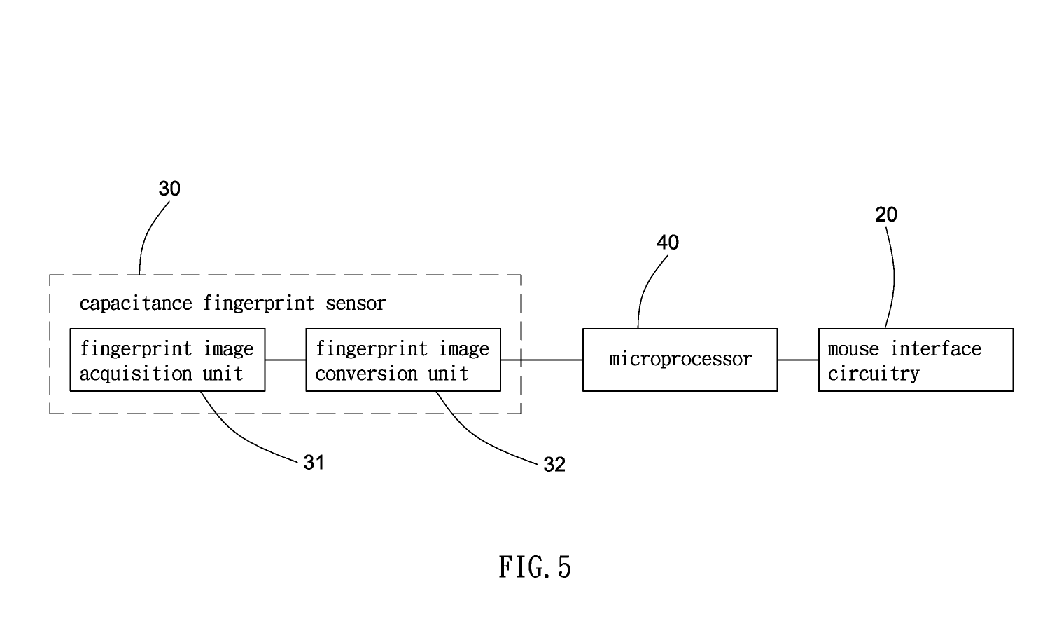

Referring to FIGS. 1 to 5, a mouse in accordance with the invention comprises housing 10, a mouse interface circuitry 20, a capacitance fingerprint sensor 30 and a microprocessor 40 as discussed in detail below.

The housing 10 includes a scroll wheel (not labeled) and left and right mouse buttons (not labeled). The housing 10 is well known in the art. Thus, its detailed description is omitted herein for the sake of brevity. The housing 10 further comprises a cavity 11 on a top. The capacitance fingerprint sensor 30 is disposed in the cavity 11.

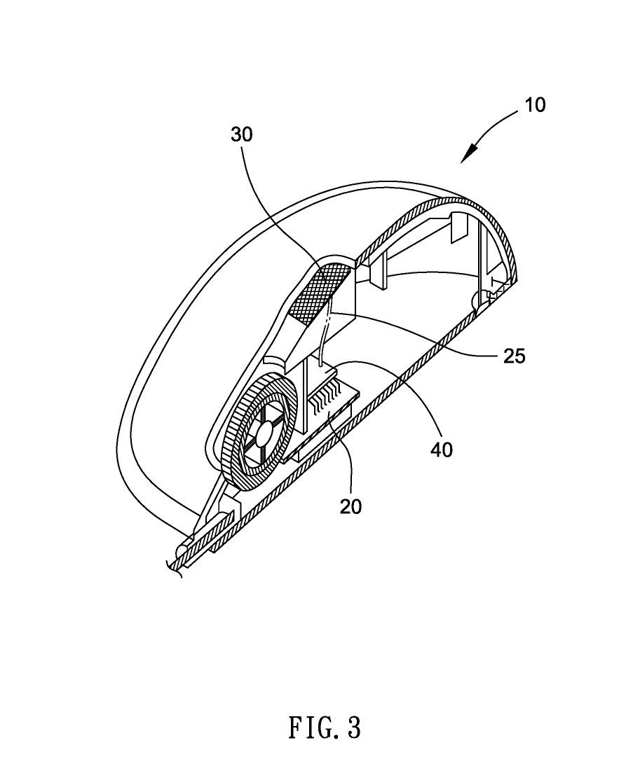

The mouse interface circuitry 20 is disposed in the housing 10 and electrically connected to the microprocessor 40. The capacitance fingerprint sensor 30 is electrically connected to the mouse interface circuitry 20. As shown in FIG. 3, a wire 25 is interconnected the capacitance fingerprint sensor 30 and the mouse interface circuitry 20. The capacitance fingerprint sensor 30 includes a fingerprint image acquisition unit 31 for capturing a user's fingerprint when the user's finger is positioned on the capacitance fingerprint sensor 30, and a fingerprint image conversion unit 32 for converting the user's fingerprint into fingerprint signals.

The microprocessor 40 is disposed on the mouse interface circuitry 20 and electrically connected to the capacitance fingerprint sensor 30. The microprocessor 40 is configured to receive the fingerprint signals, analyze same, and ultimately identify the fingerprint. Thus, the mouse may be used to identify users who wish to access a computer.

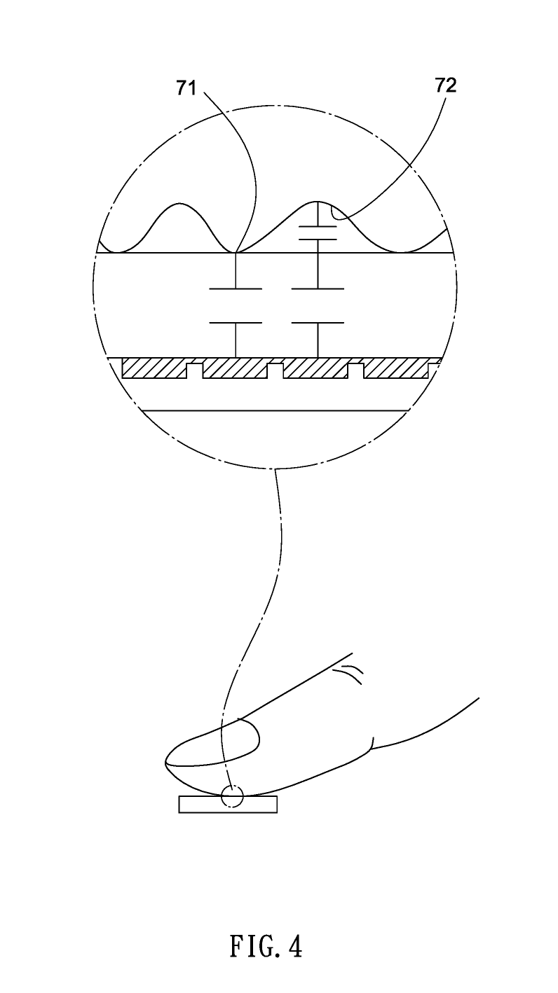

The capacitance fingerprint sensor 30 is implemented as a semiconductor sensor having a plurality of sensing electrodes for capturing a digital image of ridges and valleys of a fingerprint pattern. As shown in FIG. 4, there is a difference between capacitance of a ridge 72 of the fingerprint and capacitance of a valley 71 of the fingerprint when the user's finger is positioned on the capacitance fingerprint sensor 30. Thus, the capacitance fingerprint sensor 30 may capture the user's fingerprint.

While the invention has been described in terms of preferred embodiments, those skilled in the art will recognize that the invention can be practiced with modifications within the spirit and scope of the appended claims.

What is claimed is:

1. A mouse, comprising:
a housing;
a mouse interface circuitry disposed in the housing;
a capacitance fingerprint sensor disposed on the housing and electrically connected to the mouse interface circuitry; and
a microprocessor disposed on the mouse interface circuitry and electrically connected to the capacitance fingerprint sensor.

2. The mouse of claim 1, wherein the housing further comprises a top cavity with the capacitance fingerprint sensor disposed therein.

3. The mouse of claim 1, wherein the capacitance fingerprint sensor includes a fingerprint image acquisition unit for capturing a user's fingerprint when the user's finger is positioned on the capacitance fingerprint sensor, and a fingerprint image conversion unit for converting the user's fingerprint into fingerprint signals.
